(19) United States
(12) Patent Application Publication
(10) Pub. No.: US 2014/0197066 A1
(43) Pub. Date: Jul. 17, 2014

(54) COMPOSITE FILM FOR PRODUCTION OF MOULDED PACKAGING, METHOD FOR PRODUCTION OF A COMPOSITE FILM AND A MOULDED PACKAGING, AND MOULDED PACKAGING

(71) Applicants: Oliver Brandl, Konstanz (DE); Peter Claessens, Gottmadingen (DE); Angelika Merthan, Konstanz (DE)

(72) Inventors: Oliver Brandl, Konstanz (DE); Peter Claessens, Gottmadingen (DE); Angelika Merthan, Konstanz (DE)

(73) Assignee: AMCOR FLEXIBLES SINGEN GMBH, Singen (DE)

(21) Appl. No.: 14/110,024

(22) PCT Filed: Mar. 26, 2012
(86) PCT No.: PCT/EP12/01308

§ 371 Date: Mar. 24, 2014

(30) Foreign Application Priority Data
Apr. 8, 2011 (DE) 10 2011 001 929.4

(51) Int. Cl. B32B 15/085; B32B 7/02; B65D 75/32; B32B 27/08; B65B 43/08; B65B 11/58

(52) U.S. Cl. CPC B32B 15/085; B65B 43/08; B65B 11/58; B65D 75/326; B32B 27/08; B32B 7/02
USPC 206/532; 156/308.2; 53/453; 206/524.3; 428/339; 428/215

(57) ABSTRACT

A laminated film for production of molded packaging, in particular blister packs, with a layer structure comprising an inner first plastic layer, in particular of HDPE, an aluminum layer, which is connected with the first plastic layer by way of a connecting layer, and on the side opposite the first plastic layer is connected, preferably by way of a primer layer and a further connecting layer, to a second plastic layer, in particular comprising OPA. The second plastic layer is connected to a PET layer by way of a connecting layer and that the PET layer has a thickness between 150 μm and 300 μm, preferably a thickness between 200 μm and 300 μm.

The invention concerns a composite film for production of moulded packaging according to the preamble of claim 1. Furthermore, the invention concerns a method for production of a composite film, a method for production of a moulded packaging and a moulded packaging.

A laminated film for production of moulded packagings according to the preamble of claim 1 is known under the trademark Formpack® by the applicant. Such a laminated film which is made up of several layers typically has a first plastic layer of OPA with a layer thickness of 25 μm, an aluminium layer with thickness of 45 μm to 60 μm, and on the side of the aluminium layer opposite the OPA an HDPE, PP or PVC layer joined to the aluminium layer and with a typical thickness of 30 μm to 100 μm. Such a layer structure, which has connecting layers between the individual layers, can be cold-formed so that recesses for moulded packaging in the form of blisters, in particular for pharmaceutical products such as tablets or capsules, can be formed which are then closed with a sealing film consisting for example of aluminium. This known laminated film has excellent barrier properties from the aluminium layer, in particular against vapour, air, light, oxygen etc., wherein the aluminium layer is not damaged or broken on cold-forming.

However, it has proved disadvantageous in practice that there are applications in which an increased stiffness of the laminated film is desirable in order to avoid bulging of the laminated film e.g. during transport or use of the moulded packaging by the user.

It is furthermore known from the prior art that e.g. a plastic layer of PET with a thickness of between 500 μm and 700 μm has increased stiffness in comparison with the laminated film according to the preamble of claim 1. However, such a plastic layer has the disadvantage that as a result of its thickness, it can only be moulded into blisters by thermoforming, and in addition does not have the good barrier properties of the laminated film by the applicant cited initially.

The object of the invention is therefore to refine a laminated film for production of moulded packaging according to the preamble of claim 1 such that this has increased stiffness in relation to the prior art and at the same time good barrier properties.

This object is achieved with a laminated film for production of moulded packaging with the features of claim 1 in essence in that the second plastic layer is joined to a polyester layer by way of a connecting layer, and that the polyester layer has a thickness between 100 μm and 1000 μm, preferably a thickness between 200 μm and 300 μm. It has proved advantageous if the polyester layer comprises polyalkylene terephthalates such as polyethylene terephthalates, where applicable polybutylene terephthalates, polytetramethylene terephthalates or further polyesters, or contains these polymers. Typical polyalkylene terephthalates are A-PET, PETP, GPET or PEN. However, other thermoformable plastic films, such as PVC, PP, COC, nonwovens etc., can also be used.

In comparison with the conventional thicknesses of the PET layer which are known from the prior art, a value range is selected for the polyester layer thickness which lies clearly below the layer thicknesses normally used. In addition, in thermoforming damage to the aluminium layer serving as barrier layer in the laminated film is avoided so that the laminated film, while having a high stiffness, at the same time has unchanged good barrier properties.

Advantageous refinements of the laminated film according to the invention are given in the sub-claims.

It has proved advantageous in practice if the first plastic layer comprises polyolefins such as polyethylene or polypropylene and particularly advantageously HDPE, and has a thickness between 30 μm and 50 μm, in particular a thickness of around 40 μm, if the aluminium layer has a thickness between 25 μm and 100 μm, in particular a thickness of 50 μm, and if the second plastic layer comprises for example polyamides, preferably oriented polyamides (OPA) such as polyamide 6, polyamide 11, polyamide 12, polyamide 6.6, polyamide 6.10 etc., and has a thickness between 15 μm and 35 μm, in particular a thickness of 25 μm. Other films of PP or PET can be used to support the tear-free nature of the aluminium layer.

The invention also comprises a method for production of a laminated film according to the invention. Here it is provided that the first layer structure is joined to the second plastic layer, for example by extrusion laminating, in particular however by means of a laminating or layering process. The surfaces of the individual layers, in particular films or foils, can be pre-treated by corona treatment and/or with a primer. The individual layers can be mutually joined with an adhesion promoting agent, adhesive, lacquer laminating adhesive, as a connecting layer. Typical adhesives are solvent-containing or solvent-free or watery acrylate adhesives or polyurethane adhesive systems.

The individual foils or films can be coloured and/or printed and/or back-printed.

Furthermore, the invention also comprises a method for production of a moulded packaging of a laminated film according to the invention, wherein the laminated film is formed by a thermoforming process into a moulded packaging with recesses to hold objects. Furthermore, it is provided that the recesses which are produced in this way and filled in particular with pharmaceutical products are then closed by sealing with a cover foil.

Further advantages, features and details of the invention arise form the description below of preferred embodiment examples and with reference to the drawing.

These show:

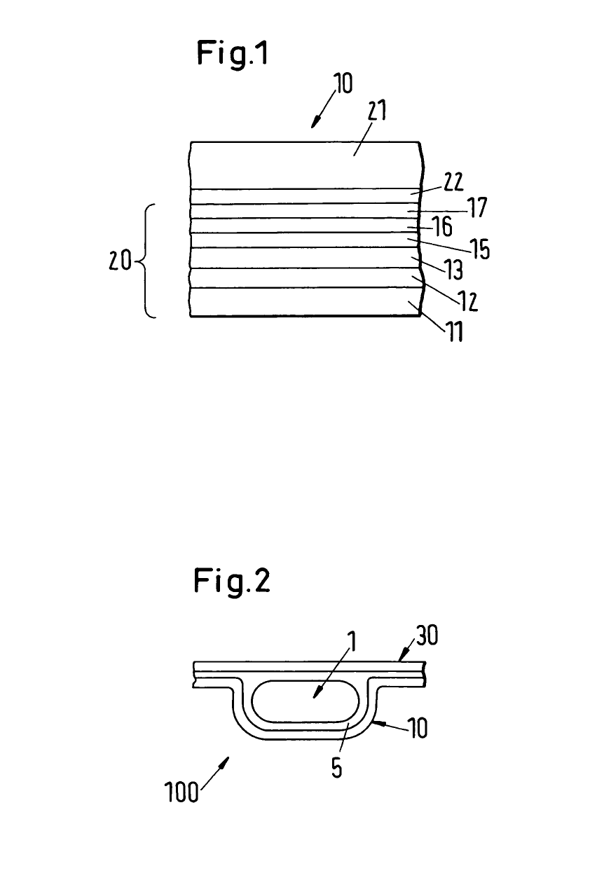

FIG. 1 a cross section through a laminated film according to the invention for production of moulded packaging, and

FIG. 2 a partial region of a blister pack using a laminated film according to the invention in longitudinal section.

FIG. 1 shows the fundamental structure of a laminated film 10 according to the invention. The laminated film 10 has a first plastic layer 11 which preferably comprises HDPE (high density polyethylene) and has a thickness between 30 μm and 50 μm, in particular a thickness of around 40 μm.

Instead of HDPE as a first plastic layer 11, other sealing layers can be used comprising PCV, PET, PP, modifications thereof and sealable lacquers with a thickness between 1 μm (for lacquers) and 200 μm.

The first plastic layer 11 is connected to the aluminium layer 13 acting as a barrier layer by way of a connecting layer 12 which in particular comprises a basis of polyurethane (PUR) and has a thickness for example of 3 μm.

The aluminium layer 13 preferably has a thickness between 25 μm and 100 μm, preferably a thickness of around 50 μm. On the side of the aluminium layer 13 opposite the connecting layer 12 is a primer layer 15 with a thickness for example of 1.6 μm and a connecting layer 16 with a thickness for example of 3.5 μm.

The connecting layer 16 is connected to a second plastic layer 17 which preferably comprises OPA (oriented polyamide), wherein the second plastic layer 17 preferably has a thickness between 15 μm and 35 μm, in particular around 25 μm.

Layers 11 to 17 form a first layer structure 20 which in particular is connected by way of a laminating process with a PET layer 21 (polyethylene terephthalate) serving to increase the stiffness of the composite film 10, wherein between the PET layer 21 and the second plastic layer 17 is arranged a further connecting layer 22 with a thickness for example of 3.5 μm.

The PET layer 21 has a thickness between 100 μm and 1000 μm, preferably a thickness between 200 μm and 300 μm.

The laminated film 10 which is formed in this way serves for production of the moulded packagings 100 shown in part in FIG. 2. The moulded packagings 100 are in particular formed as so-called blister packs and serve to hold pharmaceutical products 1 such as tablets or capsules.

For production or formation of the moulded packagings 100, the laminated film 10 according to the invention is moulded in a thermoforming process, wherein the laminated film 10 can be preheated for example to a temperature of around 160° C. In thermoforming, in the strip-like laminated film 10, recesses 5 are made in particular with even spacing next to or behind each other to hold the pharmaceutical products 1. After filling the recesses 5 with the pharmaceutical products 1, the recesses 5 are closed with a sealing film 30 also comprising for example aluminium and acting as a cover film, in that the sealing film 20 is sealed onto the composite film 10 with the aid of heat and pressure.

The laminated film 10 according to the invention can be modified or adapted in various ways without deviating from the inventive concept.

In particular the individual components of layers 11 to 17 may vary with regard to material and with regard to the thicknesses used in the embodiment examples described. Furthermore, it is evidently also conceivable that the moulded packagings 100 have a different shape or are suitable for holding objects other than pharmaceutical products 1. The use of connecting layers between the individual functional layers may be omitted, for example by direct extrusion of a plastic layer onto a carrier layer.

### LIST OF REFERENCE NUMERALS

1 Pharmaceutical product
5 Recess
10 Laminated film
11 First plastic layer
12 Connecting layer
13 Aluminium layer
15 Primer layer
16 Connecting layer
17 Second plastic layer
20 Layer structure
21 PET layer
22 Connecting layer
30 Sealing film
100 Moulded packaging

1. A laminated film for production of molded packagings with a layer structure comprising an inner first plastic layer an aluminium layer which is connected to the first plastic layer and on the side opposite the first plastic layer is connected to, a second plastic layer, wherein the second plastic layer is connected to a PET layer, and wherein said PET layer has a thickness between 100 μm and 1000 μm.

2. The laminated film according to claim 1, wherein said first plastic layer comprises HDPE and has a thickness between 30 μm and 50 μm, and said aluminium layer has a thickness between 25 μm and 100 μm, and said second plastic layer comprises OPA and has a thickness between 15 μm and 35 μm,

3. A method for production of a laminated film according to claim 1, wherein the layer structure is produced separately from the PET layer and then connected to the PET layer.

4. The method according to claim 3, wherein the connection between the layer structure and the PET layer is achieved by means of a laminating process.

5. The method for production of a molded packaging from a laminated film according to claim 1, wherein the laminated film is molded by a thermoforming process into a moulded packaging with recesses to hold objects and wherein the molded packaging, after filling with products, is closed tightly by sealing with a cover film.

6. The method according to claim 5, wherein the laminated film is heated before the thermoforming process to a temperature of around 160° C.

7. A molded packaging comprising a laminated film according to claim 1.

8. A molded packaging comprising a laminated film according to claim 2.

9. The laminated film according to claim 1, wherein said inner first plastic layer is comprised of HDPE.

10. The laminated film according to claim 1, wherein said aluminum layer is connected to said first plastic layer by way of a connecting layer.

11. The laminated film according to claim 1, wherein said second plastic layer is connected to said aluminum layer by way of a primer layer and further connecting layer.

12. The laminated film according to claim 1, wherein said second plastic layer is comprised of OPA.

13. The laminated film according to claim 1, wherein said second plastic layer is connected to said PET layer by way of a connecting layer.

14. The laminated film according to claim 1, wherein said PET layer has a thickness between 200 μm and 300 um.

15. A blister pack comprising a laminated film according to claim 1.

16. The laminated film according to claim 9, wherein said first plastic layer has a thickness of 40 μm, said aluminum layer has a thickness of 50 μm, and said second plastic layer has a thickness of 25 μm.
